(19) United States
(12) Patent Application Publication
(10) Pub. No.: US 2025/0316427 A1
(43) Pub. Date: Oct. 9, 2025

(54) KEY DEVICE

(71) Applicant: SUNREX TECHNOLOGY CORP., Taichung City (TW)

(72) Inventors: Hua HUANG, Changshu (CN); Jia-Hao PAN, Changshu (CN)

(21) Appl. No.: 18/760,510

(22) Filed: Jul. 1, 2024

(30) Foreign Application Priority Data
Apr. 8, 2024 (TW) 113112957

(51) Int. Cl. H01H 13/14

(52) U.S. Cl. CPC H01H 13/14

(57) ABSTRACT

A key device includes a bottom plate, a keycap, a supporting unit, a first supporting assembly, and a second supporting assembly. The bottom plate includes first pivot connecting portions and second pivot connecting portions. The keycap is disposed on the bottom plate, and includes first pivot portions and second pivot portions. The supporting unit pivotally interconnects the bottom plate and the keycap, and includes a first stand and a second stand. The first supporting assembly is disposed on the bottom plate or the first stand and is adjacent to the first pivot connecting portions or the first lower pivot shafts. The second supporting assembly is disposed on the keycap or the first stand and is adjacent to the second pivot portions or the first upper pivot shafts.

### CROSS-REFERENCE TO RELATED APPLICATION

This application claims priority to Taiwanese Invention patent application No. 113112957, filed on Apr. 8, 2024, the entire disclosure of which is incorporated by reference herein.

### FIELD

The disclosure relates to a computer peripheral device, and more particularly to a key device having a supporting structure.

### BACKGROUND

A key device, as disclosed in Chinese Patent Publication No. CN206363935U, includes a base plate, a plastic structure, a keycap, a connection element, and two engaging structures. The keycap is disposed on the plastic structure. The connection element interconnects the plastic structure and the keycap, and is configured to guide the keycap to move toward or away from the base plate. The plastic structure includes two fixing bars. The connection element is connected to the fixing bars. The engaging structures are disposed on the base plate, and are engaged respectively with the fixing bars.

Although the above-mentioned key device may achieve its intended purpose, when the keycap is pressed and the connection element is driven to pivot, due to gaps between the components of the key device and manufacturing tolerances between the components, the keycap may rotate and wobble when being pressed. Hence, stability of the connection element, the base plate, and the keycap is poor.

### SUMMARY

Therefore, an object of the disclosure is to provide a key device that can alleviate at least one of the drawbacks of the prior art.

According to the disclosure, the key device includes a bottom plate, a keycap, a supporting unit, a first supporting assembly, and a second supporting assembly.

The bottom plate includes a pair of first pivot connecting portions and a pair of second pivot connecting portions.

The keycap is disposed on the bottom plate, and includes a pair of first pivot portions corresponding respectively to the second pivot connecting portions and a pair of second pivot portions corresponding respectively to the first pivot connecting portions.

The supporting unit pivotally interconnects the bottom plate and the keycap, and includes a first stand and a second stand connected respectively and pivotally to the first stand. The first stand includes a pair of first lower pivot shafts connected respectively and pivotally to the first pivot connecting portions, and a pair of first upper pivot shafts pivoted respectively to the first pivot portions. The second stand includes a pair of second lower pivot shafts connected respectively and pivotally to the second pivot connecting portions, and a pair of second upper pivot shafts connected respectively and pivotally to the second pivot portions.

The first supporting assembly is disposed on one of the bottom plate and the first stand. The first supporting assembly is adjacent to one of the first pivot connecting portions and the first lower pivot shafts.

The second supporting assembly is disposed on one of the keycap and the first stand. The second supporting assembly is adjacent to one of the second pivot portions and the first upper pivot shafts.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a fragmentary perspective cross-sectional view of an embodiment of a key device having a supporting structure according to the present disclosure.

FIG. 2 is a partly exploded perspective view of the embodiment.

FIG. 3 is an exploded perspective view of the embodiment.

FIG. 4 is a top planar assembled view of the embodiment.

FIG. 5 is an enlarged fragmentary perspective view of the embodiment, illustrating a first supporting assembly.

FIG. 6 is an enlarged fragmentary planar view of the first supporting assembly of the embodiment.

FIG. 7 is an enlarged fragmentary planar view of the embodiment, illustrating a second supporting assembly.

FIG. 8 is an enlarged fragmentary planar view of the first supporting assembly of another embodiment according to the present disclosure.

FIG. 9 is an enlarged fragmentary planar view of another embodiment according to the present disclosure, illustrating the second supporting assembly that is disposed on the keycap.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

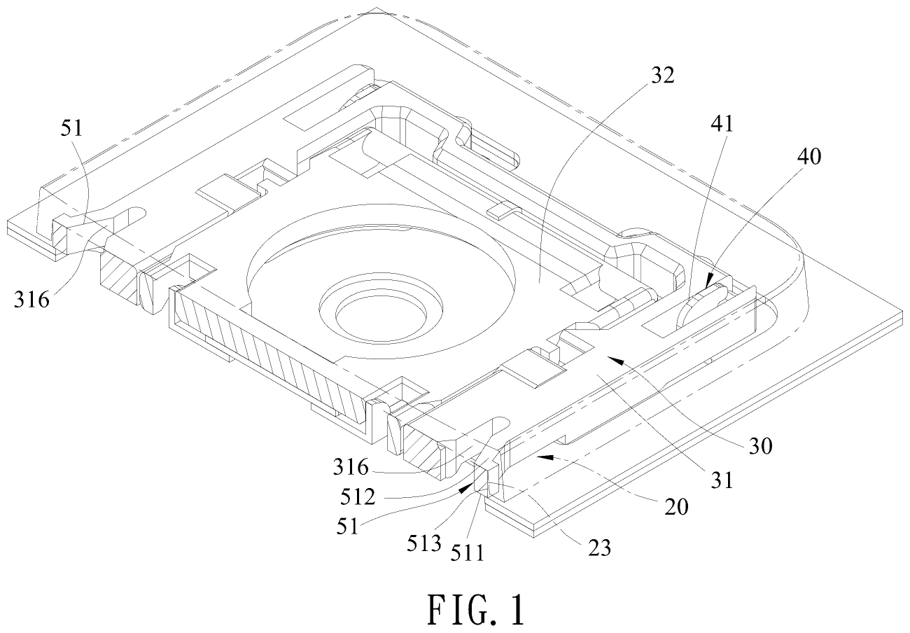

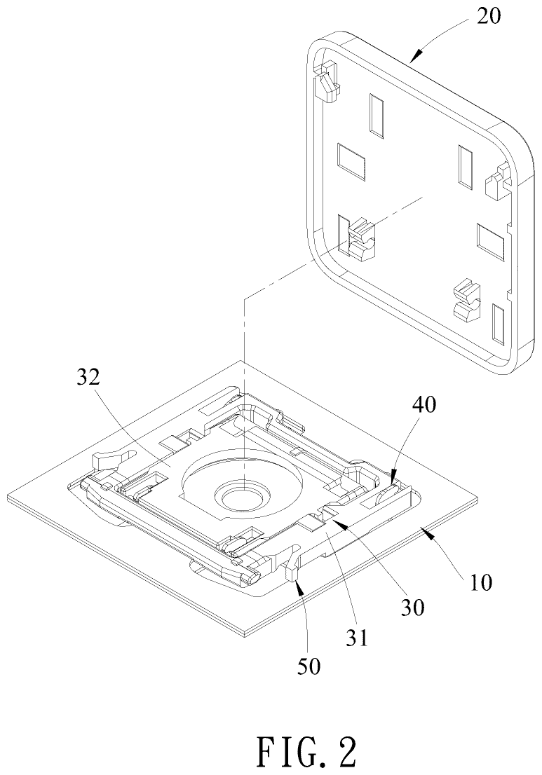

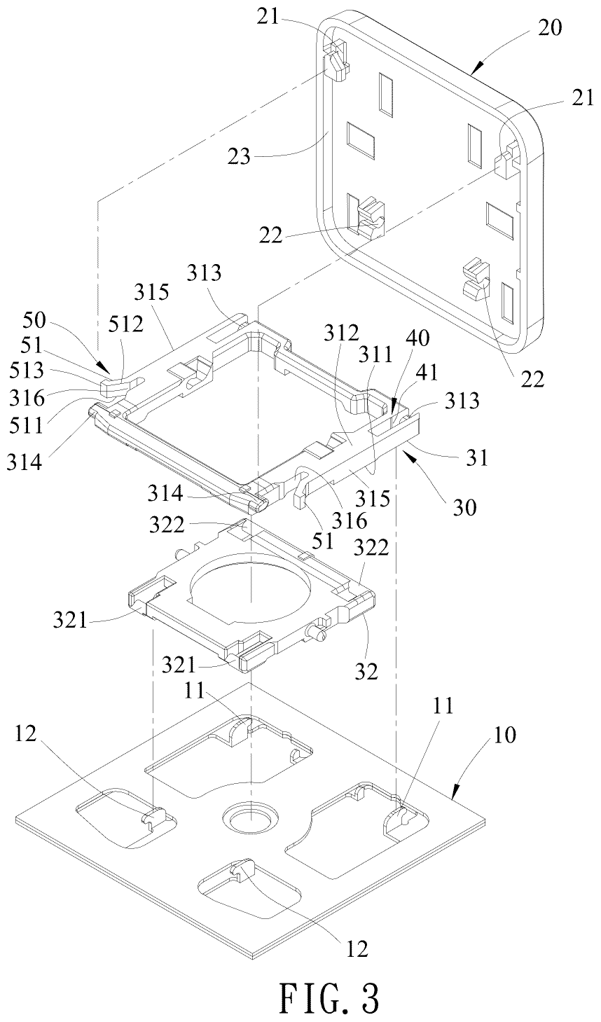

Referring to FIGS. 1 to 3, an embodiment of the key device having a supporting structure according to the present disclosure includes a bottom plate 10, a keycap 20, a supporting unit 30, a first supporting assembly 40, and a second supporting assembly 50. It should be noted that the key device may further include a resilient member disposed between the bottom plate 10 and the keycap 20. Since the resilient member is not related to the technical problem to be resolved by this disclosure, details thereof are not provided.

The bottom plate 10 includes a pair of inverted L-shaped first pivot connecting portions 11, and a pair of inverted L-shaped second pivot connecting portions 12. Each of the first pivot connecting portions 11 and the second pivot connecting portions 12 is in the form of a plate.

The keycap 20 is disposed on the bottom plate 10, and includes a pair of first pivot portions 21 corresponding respectively to the second pivot connecting portions 12, a pair of second pivot portions 22 corresponding respectively to the first pivot connecting portions 11, and an inner peripheral surface 23 surrounding peripheries of the first pivot portions 21 and the second pivot portions 22.

The supporting unit 30 pivotally interconnects the bottom plate 10 and the keycap 20. The supporting unit 30 includes a first stand 31, and a second stand 32 pivotally connected to the first stand 31. The first stand 31 includes a first bottom surface 311 facing the bottom plate 10, a first top surface 312 opposite to the first bottom surface 311, a pair of first lower pivot shafts 313 connected respectively and pivotally to the first pivot connecting portions 11, a pair of first upper pivot shafts 314 connected respectively and pivotally to the first pivot portions 21, a pair of first side surfaces 315 each connected to the first bottom surface 311 and the first top surface 312, and a pair of notches 316 formed respectively at inner sides of the first side surfaces 315.

The second stand 32 includes a pair of second lower pivot shafts 321 connected respectively and pivotally to the second pivot connecting portions 12, and a pair of second upper pivot shafts 322 connected respectively and pivotally to the second pivot portions 22.

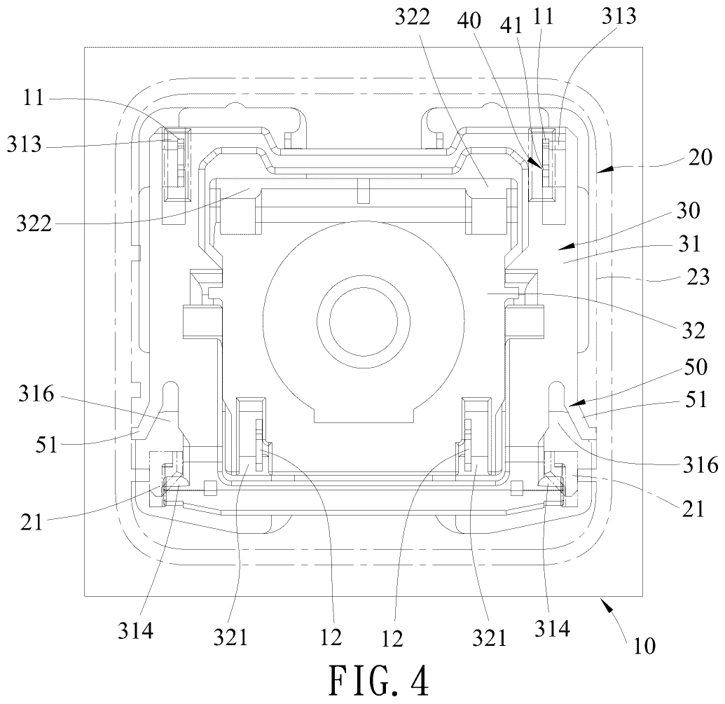

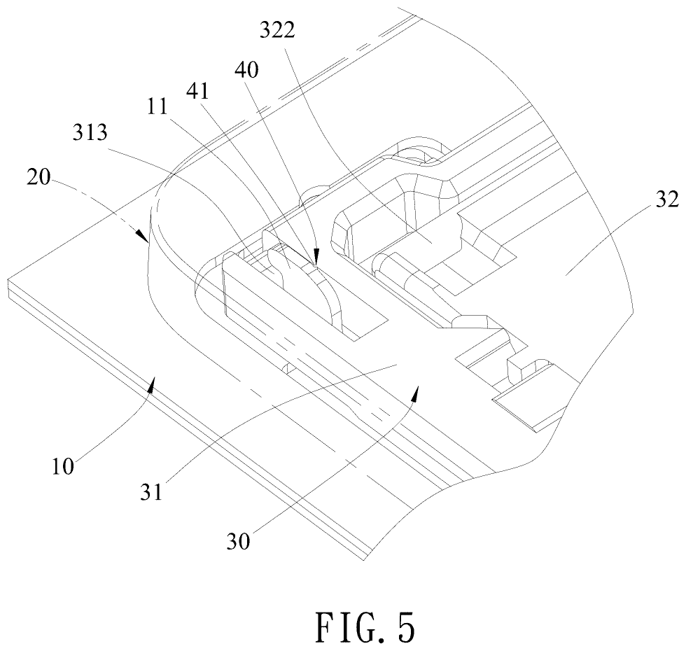

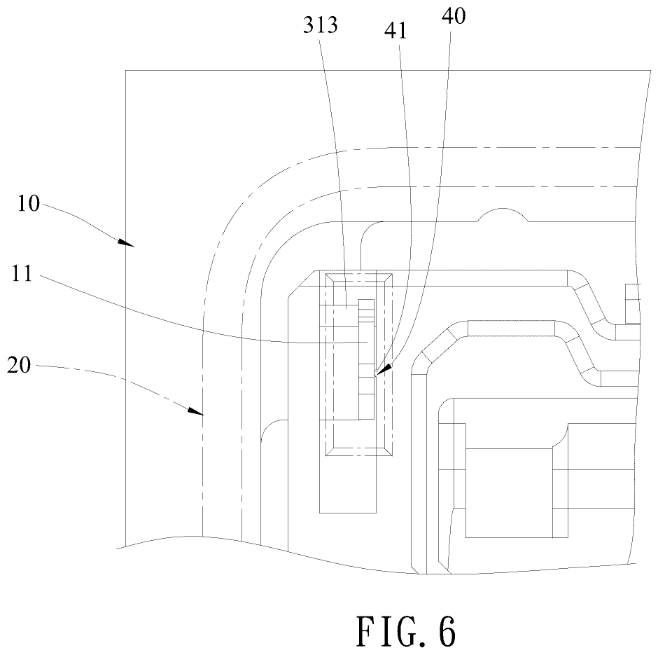

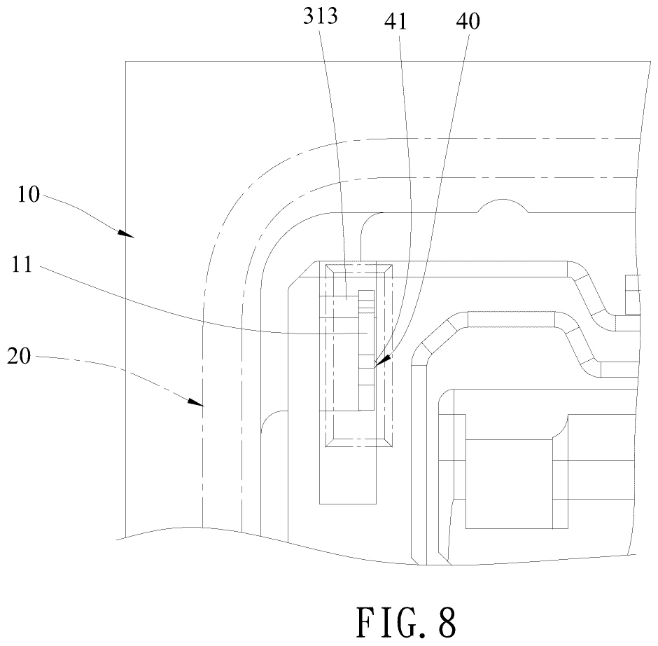

Referring to FIGS. 4 to 6, the first supporting assembly 40 may be disposed on the bottom plate 10 or the first stand 31. In this embodiment, the first supporting assembly 40 is disposed on the first stand 31, but may also be disposed on the first pivot connecting portions 11 (see FIG. 8) of the bottom plate 10. The first supporting assembly 40 is adjacent to the first pivot connecting portions 11, and includes a pair of first supporting members 41 that are adjacent to the first lower pivot shafts 313, respectively. The first supporting members 41 extend from the first bottom surface 311 to the first top surface 312, and are ridge-shaped. Each of the first supporting members 41 has an arc-shaped cross section that is parallel to the first bottom surface 311. In the embodiment of FIG. 8, the first supporting assembly 40 is adjacent to the first lower pivot shafts 313.

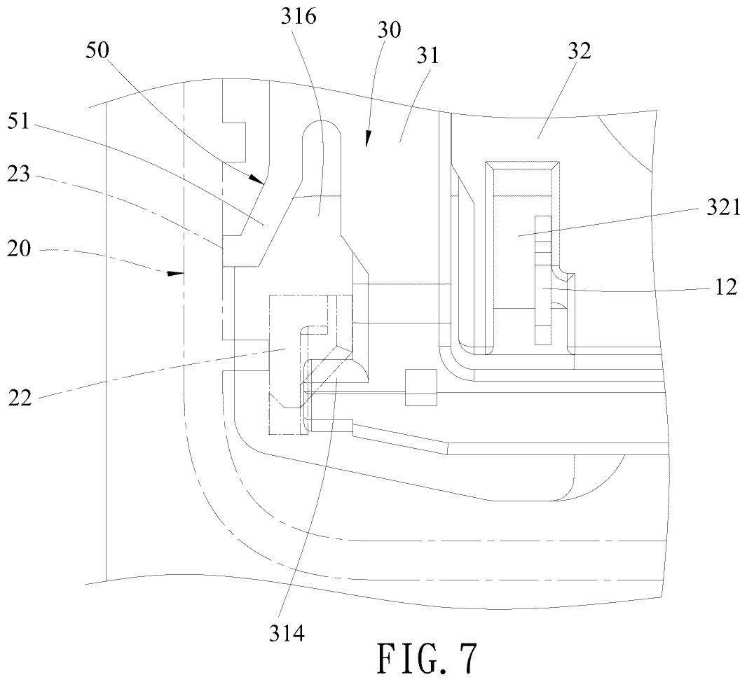

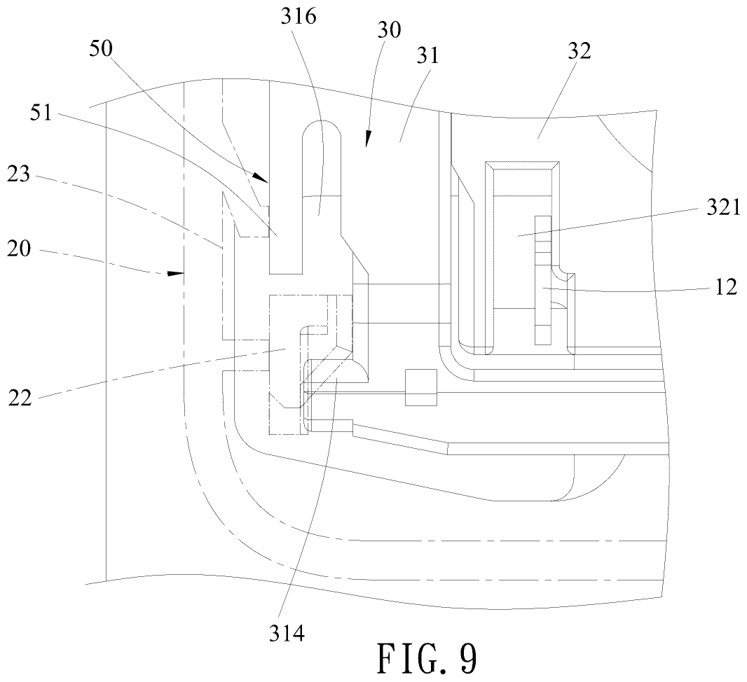

Referring to FIGS. 4 and 7, the second supporting assembly 50 is disposed on the keycap 20 or the first stand 31. In this embodiment, the second supporting assembly 50 is disposed on the first stand 31 but may also be disposed on the keycap 20 (see FIG. 9). The second supporting assembly 50 is adjacent to the first upper pivot shafts 314. The second supporting assembly 50 includes a pair of second supporting members 51 that are adjacent to the first upper pivot shafts 314, respectively. Each of the second supporting members 51 extends from a corresponding one of the first side surfaces 315 toward the inner peripheral surface 23. The second supporting members 51 are cantilevered. The second supporting members 51 do not project out over the first bottom surface 311 and the first top surface 312. Each of the second supporting members 51 is adjacent to an outer side of a corresponding one of the notches 316. Each of the second supporting members 51 has a bottom surface 511 that is substantially flush with the first bottom surface 311, a top surface 512 that is substantially flush with the first top surface 312, and an end 513 that interconnects the bottom surface 511 and the top surface 512. For each of the second supporting members 51, the end 513 is biasable relative to the corresponding one of the notches 316 and resiliently abuts against the inner peripheral surface 23. In the embodiment of FIG. 9, the second supporting assembly 50 is adjacent to the first upper pivot shafts 314.

To further understand the effects produced, the technical means, and the expected effects by the cooperation of various components of the present disclosure, they will be described again below, so a deeper and more specific understanding of the present disclosure may be obtained.

Furthermore, referring again to FIGS. 1 and 4 to 7, when the key device having the supporting structure of this disclosure is completely assembled, the first stand 31 of the supporting unit 30 is pivoted to the second stand 32. The first lower pivot shafts 313 of the first stand 31 are connected respectively and pivotally to the first pivot connecting portions 11 of the bottom plate 10. The first upper pivot shafts 314 are connected respectively and pivotally to the first pivot portions 21 of the keycap 20. The second lower pivot shafts 321 of the second stand 32 are connected respectively and pivotally to the second pivot connecting portions 12 of the bottom plate 10. The second upper pivot shafts 322 are connected respectively and pivotally to the second pivot portions 22 of the keycap 20.

Therefore, when the keycap 20 is supported by a resilient member and is in a state (not shown) away from the bottom plate 10, a user may apply a force to press the keycap 20 and move the keycap 20 toward the bottom plate 10 (i.e., in a depressed state as shown in the states of FIGS. 1 and 4 to 7).

The first supporting members 41 of the first supporting assembly 40 are disposed on the first stand 31, and the second supporting members 51 of the second supporting assembly 50 are also disposed on the first stand 31. When the keycap 20 is pressed and the first and second stands 31, 32 of the supporting unit 30 are pivoted, by virtue of the first supporting members 41 and the first pivot connecting portions 11 restricting a position of the keycap 20, and by virtue of the second supporting members 51 and the inner peripheral surface 23 of the keycap 20 restricting the position of the keycap 20, rotation and wobbling of the keycap 20 are reduced.

In summary, the key device having the supporting structure of the present disclosure has a simple structure overall, and is easy to manufacture and assemble, so the object of the present disclosure is certainly achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A key device having a supporting structure, comprising:
a bottom plate including a pair of first pivot connecting portions and a pair of second pivot connecting portions;
a keycap disposed on said bottom plate, and including a pair of first pivot portions corresponding respectively to said second pivot connecting portions and a pair of second pivot portions corresponding respectively to said first pivot connecting portions;
a supporting unit pivotally interconnecting said bottom plate and said keycap, and including a first stand and a second stand pivotally connected to said first stand, said first stand including a pair of first lower pivot shafts connected respectively and pivotally to said first pivot connecting portions and a pair of first upper pivot shafts connected respectively and pivotally to said first pivot portions, said second stand including a pair of second lower pivot shafts connected respectively and pivotally to said second pivot connecting portions and a pair of second upper pivot shafts connected respectively and pivotally to said second pivot portions;
a first supporting assembly disposed on one of said bottom plate and said first stand, said first supporting assembly being adjacent to one of said first pivot connecting portions and said first lower pivot shafts; and
a second supporting assembly disposed on one of said keycap and said first stand, said second supporting assembly being adjacent to one of said second pivot portions and said first upper pivot shafts.

2. The key device as claimed in claim 1, wherein said first supporting assembly includes a pair of first supporting members that are adjacent to said first lower pivot shafts, respectively.

3. The key device as claimed in claim 2, wherein said first stand of said supporting unit further includes a first bottom surface that faces said bottom plate, and a first top surface that is opposite to said first bottom surface, said first supporting members of said first supporting assembly being ridge-shaped, said first supporting members extending from said first bottom surface to said first top surface, each of said first supporting members having an arc-shaped cross section that is parallel to said first bottom surface.

4. The key device as claimed in claim 3, wherein said second supporting assembly includes a pair of second supporting members that are adjacent to said first upper pivot shafts, respectively.

5. The key device as claimed in claim 4, wherein said first stand of said supporting unit further includes a pair of first side surfaces each of which is connected to said first bottom surface and said first top surface, each of said second supporting members of said second supporting assembly extending from a corresponding one of said first side surfaces and away from said first stand.

6. The key device as claimed in claim 5, wherein said second supporting members of said second supporting assembly are cantilevered, said second supporting members not projecting out over said first bottom surface and said first top surface, each of said second supporting members having a bottom surface that is substantially flush with said first bottom surface, and a top surface that is substantially flush with said first top surface.

7. The key device as claimed in claim 6, wherein said keycap further includes an inner peripheral surface that surrounds peripheries of said first pivot portions and said second pivot portions, said first stand further including a pair of notches that are formed respectively at inner sides of said second supporting members, each of said second supporting members further having an end that interconnects said bottom surface and said top surface, said end being biasable relative to a corresponding one of said notches and resiliently abutting against said inner peripheral surface.
